(19) United States
(12) Patent Application Publication
(10) Pub. No.: US 2026/0355786 A1
(43) Pub. Date: Nov. 12, 2026

(54) SCREEN

(71) Applicant: SANDVIK SRP AB, Svedala (SE)

(72) Inventor: Sami NURMINEN, Lahti (FI)

(21) Appl. No.: 19/137,940

(22) PCT Filed: Dec. 13, 2023
(86) PCT No.: PCT/EP2023/085464

§ 371 Date: Jun. 11, 2025

(30) Foreign Application Priority Data
Dec. 16, 2022 (EP) 22214188.9

(51) Int. Cl. B07B 1/28; B07B 1/42

(52) U.S. Cl. CPC B07B 1/284; B07B 1/42; B07B 2201/04

(57) ABSTRACT

A multi-deck screen for screening bulk materials includes a first deck holding a first screening media and a second deck stacked beneath the first deck holding a second screening media. The stacked first and second decks are supported and connected by upright columns, which extend between the decks towards first and second opposite ends of the decks. Each deck includes a frame having a first sidewall, an opposite second sidewall, and wherein each of the first and second decks includesat least one longitudinally centrally located unbalanced motor per sidewall of the frame for independently vibrating the first and second decks.

### FIELD OF INVENTION

This invention relates to a screen for screening materials and more particularly to a vibrating multi-deck screen for screening bulk materials.

### BACKGROUND

A variety of different crushers have evolved for processing bulk material such as stone, minerals and both domestic and industrial waste including construction materials to generate a crushed product for subsequent processing or disposal. Known crushers include cone, impact, vibration and jaw crushers. Crushers can also be categorised into mobile crushers that are readily transportable from one site to another and stationary crushers designed for large static installations that are assembled on site e.g. at a quarry or mine environment where they remain until the source of raw material is exhausted.

Generally, crushers are provided with a screen for sizing and/or removing material prior to crushing to prevent blockages in the crusher and improve crusher performance. The screens can also be employed to grade crushed materials.

In general, the known screens are typically vibrating screens made up of one to four decks which hold screening media for sizing the bulk materials and a vibrating mechanism or unbalanced motor for causing the screen to vibrate to effect the screening action. In many known screens, the multiple decks of the screen typically share a single vibrating mechanism or unbalanced motor so that all the decks are vibrated simultaneously by the shared vibrating mechanism or unbalanced motor. The screening action can be a circular motion, a linear motion, an elliptical motion screen or a combination of motions and, where the decks share the vibrating mechanism or unbalanced motor, each deck exhibits the same screening action.

Screens can also be installed at different deck inclination angles as required while and other parameters such as screening medica types etc. can be varied as required in accordance with application demands.

However, known screen suffer from a number of disadvantages. For example, known vibrating multi-deck screen must generally be of heavy steel construction to withstand the forces generated by a shared vibrating mechanism and poor screening efficiency results especially for applications where the screen has large openings in the screening media of the top deck and small openings in the screening media of the lower decks. Accordingly, selected parameters for the screen are necessarily compromised for each deck and an optimal screening action per deck is not achieved. In addition, as each deck must vibrate in the same way, it is not possible to vary the screening action between decks.

CN2865870U describes a screen made up of three inclined decks arranged in sequence in which each deck has a relatively complex vibrating mechanism which relies on counterweights connected by a shaft disposed on each side of the deck. However, the sequential deck configuration requires considerable space and is not a single multi-deck unit, the shaft required for the vibrating mechanisms of the decks can compromise screening efficiency and the vibrating mechanisms cannot be tailored and/or coordinated as required in accordance with the screening actions required at the decks.

An object of the invention is to overcome at least some of the problems of the prior art.

### SUMMARY

In one aspect there is provided a multi-deck screen for screening bulk materials comprising a first deck holding a first screening media and a second deck beneath the first deck holding a second screening media and connected to the first deck by a column, each deck comprising a frame having a first sidewall, an opposite second sidewall and first and second opposite ends, wherein at least one of the first and second decks comprises at least one longitudinally centrally located unbalanced motor per sidewall of the frame for independently vibrating the first and second decks.

In one aspects there is provided a multi-deck screen for screening bulk materials, comprising a first deck holding a first screening media and a second deck stacked beneath the first deck holding a second screening media, wherein the stacked first and second decks are supported and connected by upright columns which extend between the decks towards respective first and second opposite ends of the decks, each deck comprising a frame having a first sidewall, an opposite second sidewall, wherein each of the first and second decks comprises at least one longitudinally centrally located unbalanced motor per sidewall of the frame for independently vibrating the first and second decks.

The use of centrally located unbalanced motors for at least one deck allows at least some or all of the screening decks to be controlled and operated independently for optimal screening performance.

In some embodiments, the at least one of the first and second decks each comprises at least one longitudinally centrally located unbalanced motor per sidewall of the frame for vibrating the first and/or second decks, such that the vibration applied on the first and second decks is independent or separate from each other.

The first and second decks may be coupled onto columns via shock absorbers.

In some embodiments, each deck comprises at least one longitudinally centrally located unbalanced motor per sidewall of the frame. A circular screening action of the screening deck can therefore be achieved.

In some embodiments, the multi-deck screen comprises at least three decks wherein the first and second decks share at least one longitudinally centrally located unbalanced motor per sidewall of the first and second deck frames. The decks sharing the unbalanced motors can therefore be configured for identical screening actions.

In some embodiments, the unbalanced motor is centrally mounted on the sidewall. The sidewalls therefore serve to directly support the unbalanced motor for optimal transmission of vibrating forces.

In some embodiments, each deck comprising the at least one longitudinally centrally mounted unbalanced motor per sidewall comprises two longitudinally centrally mounted unbalanced motors per sidewall. A non-circular screening action such as linear or elliptical screening actions can therefore be achieved.

In some embodiments, each unbalanced motor comprises an encoder. The encoders facilitate co-ordination of the unbalanced motors.

In some embodiments, the encoder is integral with the unbalanced motor thus protecting the encoder and facilitating effective communication between the encoder and the unbalanced motor.

In some embodiments, the encoder is a rotary encoder mounted on a shaft of the unbalanced motor. Feedback on the rotational speed of the shaft can therefore be obtained.

In some embodiments, the multi-deck screen further comprises a frequency inverter communicable with the unbalanced motor for controlling the unbalanced motor. The frequency inverter serves to facilitate adjustment of the motor shaft angle position and speed and to control the shaft angle positions as required.

In some embodiments, the multi-deck screen further comprises a central processing unit in communication with the unbalanced motors 120, 130, the encoders and the inverters.

In some embodiments, the central processing unit is configured to co-ordinate the operation of the unbalance motors.

In some embodiments, the angle of inclination of each deck is the same or different.

In some embodiments, each deck comprises at least one shock absorber. The shock absorber can be located in each corner of the decks and mitigate the vibrational forces on the decks and supporting steel structures.

In some embodiments, the shock absorber comprises a coil or a spring such as a coil spring, rubber spring or air spring. Coils and springs are effective shock absorbers.

In some embodiments, the multi-deck screen further comprises a curtain extending between the decks to protect side plates and the like. The curtain also prevents material from falling from the decks.

In some embodiments, the invention extends to a crusher system comprising a multi-deck screen as previously defined. The crusher system can therefore include the screen and other elements such as a feed chute or conveyors.

A longitudinal direction of the screen may define a machine direction, a lateral direction of the screen is transverse the machine direction and a vertical direction of the screen is orthogonal the machine direction and the lateral direction. In some embodiments, a respective rotational axis of the unbalanced motors is arranged in the lateral direction, i.e. orthogonal the machine direction and the vertical direction.

Due to the independently controllable decks of the multi-deck screen of the invention coarse and fine materials can be separated as required by a single muti-deck screen and material to be screened can be fed to any deck of the screen as required. Accordingly, the multi-deck screen of the invention can be tailored on demand to a wide range of screening operations due to the independently operable demand controllable decks.

The multi-deck screen of the invention can be connected to automated screening systems where additional sensors can be included and parameters adjusted based on feedback from the sensors. This can be done with or without a PLC (programmable logic controller).

### BRIEF DESCRIPTION OF THE DRAWINGS

The invention will now be described, by way of example only, with reference to the accompanying drawings in which:

FIG. 1 is a perspective view from above and one side of a first embodiment of a multi-deck screen of the invention for screening bulk materials in which the screen has three decks and each deck is provided with a centrally located unbalanced motor per sidewall of its frame for independently vibrating the decks in a circular screening action and a frequency inverter (VFD) communicable with the multi-deck screen is provided in a cabinet adjacent the multi-deck screen, and

FIG. 2 is a perspective view from above and one side of a second embodiment of the multi-deck screen of the invention in which the screen has three decks and each deck is provided with two centrally located unbalanced motors per sidewall of its frame for independently vibrating the decks in a non-circular screening action such as a linear motion and two frequency inverters (VFD) communicable with the multi-deck screen are provided in cabinets adjacent the multi-deck screen.

### DETAILED DESCRIPTION OF THE INVENTION

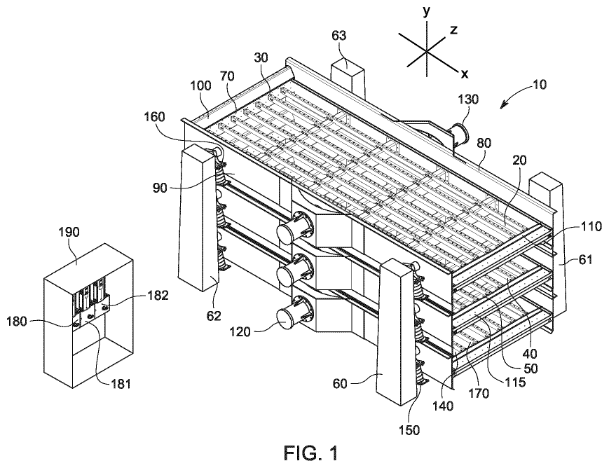

As shown in FIG. 1, a first embodiment of a multi-deck screen of the invention is generally indicated by the reference numeral 10 and is made up of a first upper screening deck 20, a second or middle screening deck 40 disposed beneath the first deck 20 and a third or lower screening deck 140 disposed beneath the second deck 40. The multi-deck screen 10 is therefore a unitary multi-deck screen 10 in which the first, second and third decks 20,40, 140 are stacked.

As derivable from FIG. 1, the decks 20, 40, 140 of the multi-deck screen are respectively arranged substantially horizontal and the decks 20, 40, 140 are stacked vertically on top of each other. The arrangement shown in FIG. 1 facilitates a compact configuration and material falling through first screen to second screen and so on.

In order to produce sized product, the first deck 20 is provided with a first deck screening media 30, the second deck 40 is provided with a second deck screening media 50 and the third screening 140 deck is provided with a third deck screening media 170. The screening media 30, 50, 170 are sized to produce oversize and throughput product as required.

The first screen media 30 provided in the first deck 20 may comprise openings that are larger than the openings in the second screen media 50 and the third screen media 170 may comprise openings that are smaller than the openings of the second screen media 50. Thus, in some embodiments one or more of the decks 20, 40, 140 are configured to produce different oversize products. For example, the decks 20, 40, 140 may be configured to produce different oversize products. By individually controlling the vibration of the decks according to aspects detailed herein, the vibration of a deck of the decks 20, 40, 240 may be adapted to the material being screened in the respective decks of the multi-deck screen for optimal screening.

In the present embodiment, each deck 20, 40, 140 is identical or similar in construction and is made up of a frame 70 having a first sidewall 80, a second sidewall 90 disposed opposite the first sidewall 80 and first and second opposite ends 100,110 with the second end 110 being open to define a sizing screen discharge end 115 for discharging screened material from the screen 10. The stacked first, second and third decks 20, 40, 140 are supported and connected by upright columns 60, 61, 62, 63 which extend between the decks 20,40, 140 towards the first and second opposite ends 100,110 of the decks 20,40,140. Each deck 20,40, 140 can have a different angle of inclination so that the decks 20,40,140 are inclined as required in accordance with the screening operation. The inclination angles can be selected for material speed and overall screening efficiency and can be defined before use and fixed at that angle.

A respective column of the columns 60, 61, 62, 63 extends between all the decks 20, 40, 140. Hence, a respective deck of the decks 20, 40, 140 may be connected to and/or suspended by each column of the columns 60, 61, 62, 63.

The columns 60, 61, 62, 63 extend in a substantially vertical direction. The columns 60, 61, 62, 63 extend in a direction which may be substantially transverse the horizontal extension of the decks 20, 40, 140.

Two columns may be provided on each lateral side of the decks 20, 40, 140. By this configuration, the weight of the screen may be reduced.

By providing a respective unbalance motor with a respective deck of the decks 20, 40, 140 according to aspects detailed herein, it is facilitated that the screen area may be increased since a respective unbalance motor of the unbalance motors do not need to accelerate any structure other than the deck it is associated with, i.e. mounted to.

In some embodiments, the decks 20,40,140 can differ in construction e.g. the first deck 20 can include a feedbox to receive material and so differ in construction.

In some embodiments, each deck 20,40,140 is provided with a centrally located unbalanced motor 120,130 per sidewall 80,90 respectively of its frame 70 for independently vibrating the three decks 20,40,140 in a circular screening action. Accordingly, the screening action of each deck 20,40,70 can be controlled independently for optimal screening performance. Each unbalanced motor 120,130 can be fitted with a selected counterweight as required in accordance with the vibrating characteristics required for the screen.

A longitudinal direction of the screen defines a machine direction x, a lateral direction z of the screen is transverse the machine direction x and a vertical direction y of the screen is orthogonal the machine direction x and the lateral direction z. In some embodiments, a respective rotational axis of the unbalanced motors 120, 130 is arranged in the lateral direction z, i.e. orthogonal the machine direction x and the vertical direction y.

In some embodiments, as shown in the drawing, each unbalanced motor 120,130 is centrally mounted directly on the sidewalls 80,90. The unbalanced motors 120,130 are each provided with an associated encoder to provide feedback on the performance (e.g. output, shaft speed etc) of the unbalanced motors 120,130. The encoder can be integral with or included in the unbalanced motors 120,130 and in one embodiment the encoder is a rotary encoder mounted on the drive shaft of the unbalanced motors 120,130. Suitable encoders are Absolute encoders which provide exact information about motor shaft position and also have safety functionality in power loss situations.

Frequency inverters (VFD) 180, 181, 182 can also be communicable with the unbalanced motors 120,130 for controlling the speed of the unbalanced motors 120,130 on each deck 20,40,140 and assisting in monitoring the screening action. In the present embodiment, a single VFD 180 controls both unbalanced motors 120,130 per deck 20,40,140 so that three VFD's 180,181,182 are provided which communicate with respective decks 20,40,140. The VFD's 181, 181, 182 can be housed in a cabinet 190 adjacent the multi-deck screen 10. The typical maximum distance between the motors 120, 130 and the VFD's 180, 181,182 in the cabinet 190 can be approximately 150 m but is dependent on the cables, fuses and temperature. As indicated above, the unbalanced motors 120, 130 are provided with encoders and the VFD's 180, 181, 182 can be adjusted to synchronize among other things motor shaft angle position and speed.

As will be appreciated by those skilled in the art, the exact type of encoder and VFD 180,181, 182 employed with the multi-deck screen 10 of the invention can be selected in accordance with the functionality required of the multi-deck screen 10 and the type of motors 120,130 employed.

As shown in the drawing, each deck 20,40,140 is provided with shock absorbers 150 which extend between the sidewall 80,90 and the columns 60,61,62,63 to modulate the deck 20,40, 140 vibrations. Suitable shock absorbers 150 can be coil spring, rubber spring (marsh mellow) or air spring shock absorbers 160 as desired. The shock absorbers 150 allow for the movement of the screen 10 and the decks 20,40,140 and serve to reduce dynamic forces on the screen 10 structure and decks 20,40,140. The shock absorbers 160 can also stabilize the multi-deck screen 10 and decks 20,40,140.

A respective deck of the decks 20, 40, 140 may be suspended by a set of such shock absorbers 150 according to embodiments herein, such as at least four shock absorbers, wherein a respective shock absorber of the set of shock absorbers connects a respective column of the columns 60, 61, 62, 63 to the respective deck.

The shock absorbers of the set of shock absorbers may be attached directly to the respective column and directly to the respective deck, such as directly to the side walls of the decks. Thereby, respective vibrations of the decks may be isolated from the columns and the other decks.

In one embodiment of the invention, the screen 10 is further provided with a curtain which extends between the decks (20,40,140) to protect side plates from material impacts.

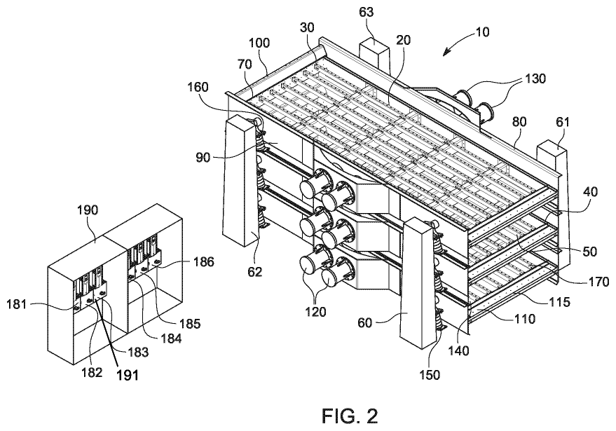

FIG. 2 shows a perspective view from above and one side of a second embodiment of the multi-deck screen 10 of the invention broadly similar to the screen 10 of FIG. 1. Accordingly, like numerals indicate like parts. However, in the present embodiment, the screen 10 has three decks 20,40,140 in which each deck 20,40,140 is provided with two centrally mounted unbalanced motors 120,130 per sidewall 80,90 of its frame 70 for independently vibrating the decks 20,40,140 in a non-circular screening action such as a linear or elliptical motion.

In the present embodiment, two VFD's are required per deck 20,40,140 to control the pair of unbalanced motors 120,130 on opposite sides 80,90 of each deck 20,40, 140. Accordingly, the cabinet 190 is provided with six VFD's 181, 182, 183, 184, 185, 186. The VFD's 181,182, 183, 184, 185, 186 are adjustable to synchronize among other things motor shaft angle position and speed and to control the shaft angle positions of motors 120,130 on the same side 80,90 of each deck 20,40,140 to achieve the different stroke motions such as linear and elliptical motions.

In another embodiment of the invention, the multi-deck screen 10, any two of the decks 20,40, 140 of a multi-deck screen 10 can share an unbalanced motor 120,130 per sidewall 80,90 of the deck frames 70 if desired.

In use, feed material is conveyed to the screen 10 for screening e.g. via a feedbox (not shown). The screen 10 is operated so that the screening media 30 of the first upper deck 20 screens the material to produce a first screen oversize product. Typically, the first deck screening media 30 is sized to size the first sizing screen oversize product in accordance with the desired size of the crushed product. The oversize product is discharged from the discharge end 115 of the first deck 20. Throughput product from the first deck 20 then extends through the screening media 50,170 of the second and third decks 40, 140 respectively in similar fashion.

As at least one of the decks 20, 40, 140 is provided with at least one longitudinally centrally located unbalanced motor 120, 130 per sidewall 80, 90 of the deck frame 70, the decks 20, 40, 140 can be independently vibrated so that the desired vibrating characteristics and screening performance of the decks 20, 140, 140 can be separately optimised as required. The encoder associated with each unbalanced motor 120,130 allows for the co-ordination of the unbalanced motors 120, 130 so that operation of the unbalanced motors 120, 130 can be synchronised as required. In addition, the inverters employed with the unbalanced motors also facilitate the control of the speed of operation of the unbalanced motors 120,130. Accordingly, the decks 20, 40, 140 of the multi-deck screen of the invention can be separately and independently controlled in a co-ordinated manner as required for optimal screening. The overall operation of the screen 10, and in particular the individual decks 20, 40, 140, of the invention can be controlled by a central processing unit 191 in communication with the unbalanced motors 120, 130, the encoders and the inverters.

In some embodiments, the central processing unit 191 may be configured to co-ordinate the operation of the unbalance motors 120, 130 such that the unbalance motors 120, 130 are syncronised.

The central processing unit may be in communication with the unbalanced motors 120, 130, the encoders and the inverters by means of a physical connection, such as a wired connection.

The central processing unit may be housed for example in the cabinet 190.

The screen 10 of the invention can be provided with a feedbox if desired for receiving and discharging bulk material. The decks 20, 40, 140 of the screen 10 can also be inclined as required if desired.

The screen 10 of the invention, and in particular the individual decks 20, 40, 140, can therefore be configured as required in accordance with the desired screening parameters resulting in highly efficient screening. Accordingly, the screen 10 can function as a universal screen and can be used to screen coarse and fine materials at the same time while the stroke shape (circular, non-circular, linear, elliptical etc) of each deck 20, 40, 140 can be adjusted as required. The use of unbalanced motors in combination with the encoders enables a simple vibrating and screening action. Increased screening areas on the screening media can also be achieved as a lighter steel construction can be employed for the screen where each deck 20, 40, 140 is provided with dedicated unbalanced motors. As a result, the first deck 20 can have larger openings in the screening media 30 and the second and third decks 40, 140 can have smaller openings without compromising screening efficiency and without the need to employ multiple screens to achieve a final product. In short, optimal screening is achieved regardless of the size of the bulk feed materials and the separation parameters required.

1. A multi-deck screen for screening bulk materials comprising:
a first deck holding a first screening media; and
a second deck stacked beneath the first deck holding a second screening media,
wherein the stacked first and second decks are supported and connected by upright columns, which extend between the decks towards first and second opposite ends of the decks,
each first and second deck including a frame having a first sidewall and an opposite second sidewall, and
wherein each of the first and second decks includes at least one longitudinally centrally located unbalanced motor per sidewall of the frame for independently vibrating the first and second decks.

2. (canceled)

3. The multi-deck screen as claimed in claim 1, further comprising at least three decks, wherein the first and second decks share the at least one longitudinally centrally located unbalanced motor per sidewall of the frames of the first and second decks.

4. The multi-deck screen as claimed in claim 1, wherein the unbalanced motor is centrally mounted on the sidewall.

5. The multi-deck screen as claimed in claim 1, wherein each deck includes two longitudinally centrally mounted unbalanced motors per sidewall.

6. The multi-deck screen as claimed in claim 1, wherein each unbalanced motor includes an encoder for the co-ordination of the unbalanced motors, so that operation of the at least one unbalanced motors can be synchronised as required.

7. The multi-deck screen as claimed in claim 6, wherein the encoder is integral with the at least one unbalanced motor.

8. The multi-deck screen as claimed in claim 7, wherein the encoder is a rotary encoder mounted on a shaft of the at least one unbalanced motor.

9. The multi-deck screen as claimed claim 1, further comprising a frequency inverter communicable with the at least one unbalanced motor for controlling the at least one unbalanced motor.

10. The multi-deck screen as claimed claim 9, further comprising a central processing unit in communication with the at least one unbalanced motor, the encoders and the inverters, and the central processing unit being configured to co-ordinate the operation of the at least one unbalanced motor.

11. The multi-deck screen as claimed in claim 1, wherein an angle of inclination of each first and second deck is the same or different.

12. The multi-deck screen as claimed in claim 1, wherein each deck comprises at least one shock absorber extending between each of the sidewalls and a respective column of the columns to modulate deck vibrations.

13. The multi-deck screen as claimed in claim 12, wherein the shock absorber comprises a coil or a spring.

14. The multi-deck screen as claimed in claim 1, further comprising a curtain extending between the first and second decks to protect side plates.

15. A crusher system comprising a multi-deck screen as claimed in claim 1.
